(19) United States
(12) Patent Application Publication
(10) Pub. No.: US 2019/0288897 A1
(43) Pub. Date: Sep. 19, 2019

(54) METHOD FOR SELECTING A DATA SIGNAL FOR GENERATING A MODULATED SIGNAL, SELECTION DEVICE AND CORRESPONDING COMPUTER PROGRAM

(71) Applicant: ENENSYS TECHNOLOGIES, Cesson-Sevigne (FR)

(72) Inventors: Benoit Bui Do, Rennes (FR); Frederic Pirot, Sens De Bretagne (FR)

(21) Appl. No.: 16/340,928

(22) PCT Filed: Oct. 10, 2017
(86) PCT No.: PCT/EP2017/075767

§ 371 Date: Apr. 10, 2019

(30) Foreign Application Priority Data
Oct. 12, 2016 (FR) 1659848

(51) Int. Cl. H04L 27/26; H04W 52/36; H04W 72/00

(52) U.S. Cl. CPC H04L 27/2614; H04L 5/0007; H04W 72/005; H04W 52/367

(57) ABSTRACT

A method of selecting a data signal implementing the following acts: a first act of modulating a first data signal carrying at least one content to be broadcast, called a first candidate signal, the first candidate signal carrying payload data and additional data associated with a communications layer; at least one second act of modulating a second data signal carrying the at least one content to be broadcast, called a second candidate signal, the second candidate signal carrying the payload data and additional data associated with the communications layer, the additional data being distributed differently in the second candidate signal, relative to the additional data of the first candidate signal; and an act of selecting from amongst the candidate signals, the candidate signal for which the modulation delivers a modulated signal having a peak-to-average power ratio (PAPR) meeting a predetermined criterion.

### FIELD OF THE INVENTION

The field of the invention is that of communications implementing a multicarrier modulation, for example OFDM (orthogonal frequency division multiplex) type modulation.

More specifically, the invention proposes a solution to optimize the peak-to-average power ratio (PAPR) of the multicarrier signal. It may be recalled that such a ratio, here below denoted as PAPR, characterizes the dynamic range of the modulated signal or more specifically the difference between the maximum value of the power of this signal and its average value.

The invention can be applied more particularly but not exclusively to the broadcasting of modulated signals in broadcasting networks, whatever the broadcasting standard used:
DVB-T or DVB-T2 (Digital Video Broadcasting—Terrestrial);
ATSC-3 (Advanced Television Systems Committee);
ISDB-T (Integrated Services Digital Broadcasting—Terrestrial);
LTE (Long Term Evolution), and especially eMBMS (evolved Multimedia Broadcast/Multicast Service);
Other present or future standards.

### PRIOR ART

Most high-bit-rate digital transmissions rely on the use of OFDM modulation. Indeed, such a transmission technique has numerous advantages, especially in the context of multipath channels, in countering the effects of fading phenomena in frequency-selective channels.

However, one drawback of a transmission technique based on OFDM modulation is its high PAPR level.

Indeed, in the context of a broadcasting network for example, implementing a network head-end and a plurality of distant transmission sites, the multicarrier signal that is output from a modulator must be amplified in power, the geographical coverage of the transmission sites being directly correlated to the power of the signal. Unfortunately, this amplification can introduce non-linearities if the PAPR level of the multicarrier signal is high, degrading the signal sent and thus reducing the coverage.

This is why the power amplifier must be used in its zone of linearity and not in its saturation zone (i.e. the zone with high non-linearities). On the other hand, to augment its power efficiency, the amplifier must be used as close as possible to its saturation zone. It is therefore sought to obtain the most satisfactory trade-off between the integrity of the signal and efficiency when defining the zone of use of the amplifier. This zone is defined by a distance to the saturation zone called a “back-off”. Now, the definition of the back-off takes account of the dynamic range of the signal to be amplified, i.e. the value of its PAPR. The higher this value, the greater the back-off, and this results in a drop in efficiency.

By reducing the PAPR upstream to the power amplification, the back-off can be reduced, improving its power efficiency, and this improves the power consumption at transmission site.

Several techniques have been proposed for reducing the PAPR at the transmission sites. Most of these techniques are implemented in the processing of the modulation of the physical communications layer (L1). However, these approaches have several drawbacks.

In particular, several PAPR-reducing techniques reduce the bandwidth for the payload data. Indeed, according to these techniques, certain carriers are allocated exclusively to the processing of the PAPR, thus reducing the number of carriers allocated to payload data.

Other PAPR-reducing techniques are incompatible with certain transmission standards.

In addition, the prior-art PAPR-reducing techniques are designed to be implemented at the transmission sites of a broadcasting network. This means that the associated processing operations are duplicated on all the modulators/transmitters of the network. Now, in practice, the population of modulators/transmitters of a network can be heterogeneous. In other words, not all the modulators/transmitters come from the same manufacturer. The implementation of even standardized PAPR-reducing techniques may differ from manufacturer to manufacturer, so much so that their result in terms of PAPR reduction may differ.

There is therefore a need for a novel solution to generating a multicarrier signal having reduced PAPR.

### SUMMARY OF THE INVENTION

To this end, the invention proposes a method for selecting a data signal implementing the following steps:
a first step for modulating a first data signal carrying at least one content to be broadcast, called a first candidate signal,
at least one second step for modulating a second data signal carrying said at least one content to be broadcast, called a second candidate signal, said second candidate signal having a structure and/or at least one piece of data different from said first candidate signal,
a step of selection, from amongst said candidate signals, of the candidate signal for which the modulation delivers a modulated signal having a peak-to-average power ratio (PAPR) complying with a predetermined criterion.

According to the invention, action is therefore taken on the data signal and not on the modulation processing to optimize the PAPR of the corresponding modulated signal.

More specifically, several different versions of the data signal, called candidate signals, are built and the PAPR of a modulated signal obtained from each version of the data signal is evaluated in order to select, for example, the version that leads to the modulated signal having the lowest PAPR.

In other words, numerous scenarios are created by playing on different mechanisms of the communications layers upstream to the modulation processing operation. By evaluating the PAPR for each of these scenarios and by choosing, for example, only the scenario that leads to the lowest value, the PAPR of the transmitted modulated signal is reduced.

The evaluation of the PAPR can rely on a classic modulation chain, for example located at the network head-end if the method of selection is implemented at the network head-end. This chain can be duplicated for each scenario or its rate can be increased in order to evaluate several scenarios per cycle and limit the duplication. The selection is made by choosing for example the scenario that leads to the minimum PAPR value.

The creation of scenarios, i.e. candidate signals, relies on the use of degrees of freedom of the mechanisms of the communications layers. It is thus proposed according to the invention to re-utilize existing mechanisms, which may possibly be standardized, in order to assign them a new function. The mechanisms envisaged are for example signaling, padding and/or proprietary data.

These mechanisms have no impact on the payload data but on the additional data. They modify the data signal, for example the transport stream output from the network head-end. Now, a small variation in this stream can be enough to produce a different PAPR value in the transmission sites through the use of several interleavers (bit, frequency, time) in the modulation processing operations. It will be noted that, since the payload data are not modified, the content to be broadcast is not degraded.

The invention also relates to a selection device and to a corresponding computer program.

The selection technique according to the invention can therefore be implemented in various ways, especially in hardware form and/or in software form.

For example, at least one step of the selection technique according to the invention can be implemented:
on a reprogrammable computing machine (a computer, a processor, for example a DSP or digital signal processor, a microcontroller etc.) executing a program comprising a sequence of instructions,
or on a dedicated computation machine (for example a set of logic gates such as an FPGA (Field Programmable Gate Array) or an ASIC (Application-Specific Integrated Circuit) or any other hardware module.

In particular, the computer program can use any programming language whatsoever and can be in the form of source code, object code or intermediate code between source code and object code such as in a partially compiled form or in any other desirable form whatsoever

### LIST OF FIGURES

Other features and advantages of the invention shall appear more clearly from the following description of one particular embodiment, given by way of a simple illustratory and non-exhaustive example and from the appended drawings, of which:

FIG. 1 presents the main steps of a method for selecting a data signal according to one embodiment of the invention;

FIGS. 2A to 2C illustrate the implementing of the selection technique in a broadcasting network according to one embodiment of the invention;

FIGS. 3 to 5 illustrate the generating of candidate signals by the modification respectively of a value, a length, a position of at least one signaling data;

FIG. 6 presents the generation of candidate signals by modifying a value of at least one piece of padding data;

FIGS. 7 to 9 illustrate the generation of candidate signals by modifying the position of at least one piece of padding data according to different standards;

FIG. 10 presents the simplified structure of a device for selecting a data signal according to one particular embodiment of the invention.

### DESCRIPTION OF ONE EMBODIMENT OF THE INVENTION

### General principle

The general principle of the invention relies on the selection of a data signal leading to the generation of a modulated signal having optimized PAPR. In particular, for an implementation in a broadcasting network comprising a network head-end and a plurality of distant transmission sites, such a selection technique is implemented upstream to the modulators of the transmission sites.

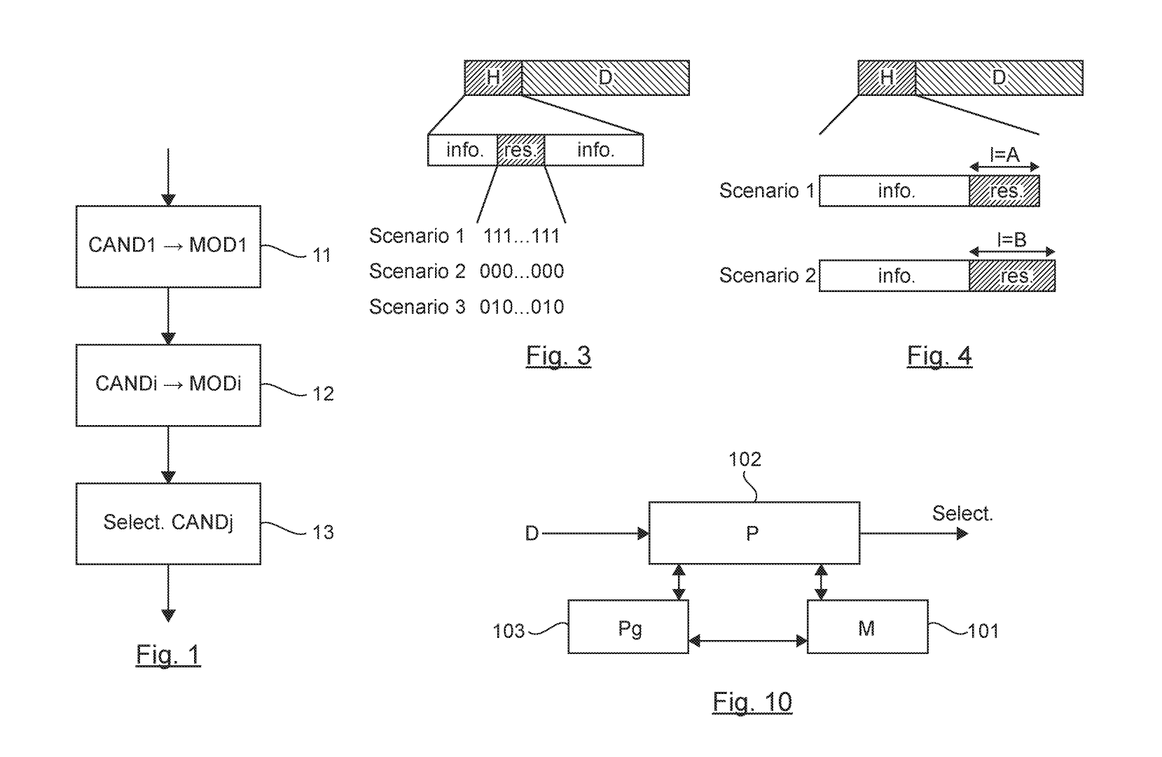

FIG. 1 presents the main steps implemented by a method for selecting a data signal according to the invention.

During a first step 11, a first candidate data signal CAND1 carrying at least one content to be broadcast is modulated. For example, the first signal MOD1 is obtained by modulating the first candidate signal CAND1 according to an OFDM modulation.

During a second step 12, a second candidate data signal CAND2 is modulated. This second signal CAND2 carries the same content to be broadcast as the first candidate signal CAND1, i.e. the same payload data. For example, the second signal MOD2 is obtained by modulating the second candidate signal CAND2 according to a OFDM modulation. The second candidate signal CAND2 has a structure and/or at least one piece of data different from the first candidate signal CAND1.

It can be noted that the second step 12 can be repeated several times so as to obtain a plurality of modulated signals, each modulated signal MODi being obtained by modulating an i^{th} candidate data signal CANDi carrying the same content to be broadcast as the first candidate signal CAND1, i.e. the same payload data but with a different structure and/or at least one different piece of data.

For example, the second step 12 is iterated according to a predefined number of iterations. Thus, if the number of candidate signals is fixed at N, the second step can be iterated N−1 times. It can also be repeated so long as a modulated signal with a PAPR value lower than a predetermined threshold has not been obtained. It can be noted that the greater the number of iterations, the higher the chance of obtaining a low PAPR value.

At the end of the second step 12, there is therefore a set of at least two candidate signals.

During a selection step 13, a selection is made, from the set of at least two candidate signals, of the candidate signal for which the modulation delivers a modulated signal with a PAPR value that meets a predetermined criterion. In particular, it is noted that the PAPR of the modulated signal can be measured on the signal in quantified form (I/Q) or on the corresponding radiofrequency signal. For example, the candidate signal CANDj selected is the one that leads to the generation of the modulated signal MODj of the lowest PAPR value. As a variant, the candidate signal CANDj selected is the one leading to the generation of the modulated signal MODj having a PAPR value below a predetermined threshold. According to this variant, if several candidate signals lead to the generation of a modulated signal with a PAPR value below a predetermined threshold, then the candidate signal that is easiest to build can be chosen.

Thus, several scenarios are built, each leading to a different PAPR value, and that scenario which enables the PAPR of the modulated signal to be optimized is chosen. Statistically, the PAPR of the modulated signal generated from the candidate signal selected according to the invention is smaller than the PAPR of a modulated signal generated from any unspecified data signal. It can also be noted that the greater the number of scenarios, the greater the likely reduction of the PAPR.

In particular, the candidate signals carry the same content, i.e. the same payload data but they include additional data having a value and/or a length and/or a position that are different. Such additional data are for example of the signaling, padding and/or proprietary type. Since the payload data are not modified according to the invention, the content or contents to be broadcast are not degraded.

Such additional data are classically provided in data signals. It is proposed according to the invention to use these additional data to build different candidate signals and select the signal that enables the generation of a modulated signal having optimized PAPR. In this way, the invention uses the additional data for a twofold purpose, namely the classic transmission of signaling, padding and/or proprietary information and the optimizing of the PAPR, thus preventing additional bandwidth losses as in certain prior-art PAPR-reduction techniques.

In particular, it can be noted that the building of the different candidate signals can be implemented on different communications layers and not only on the physical layer.

### Implementation in a Broadcasting Network

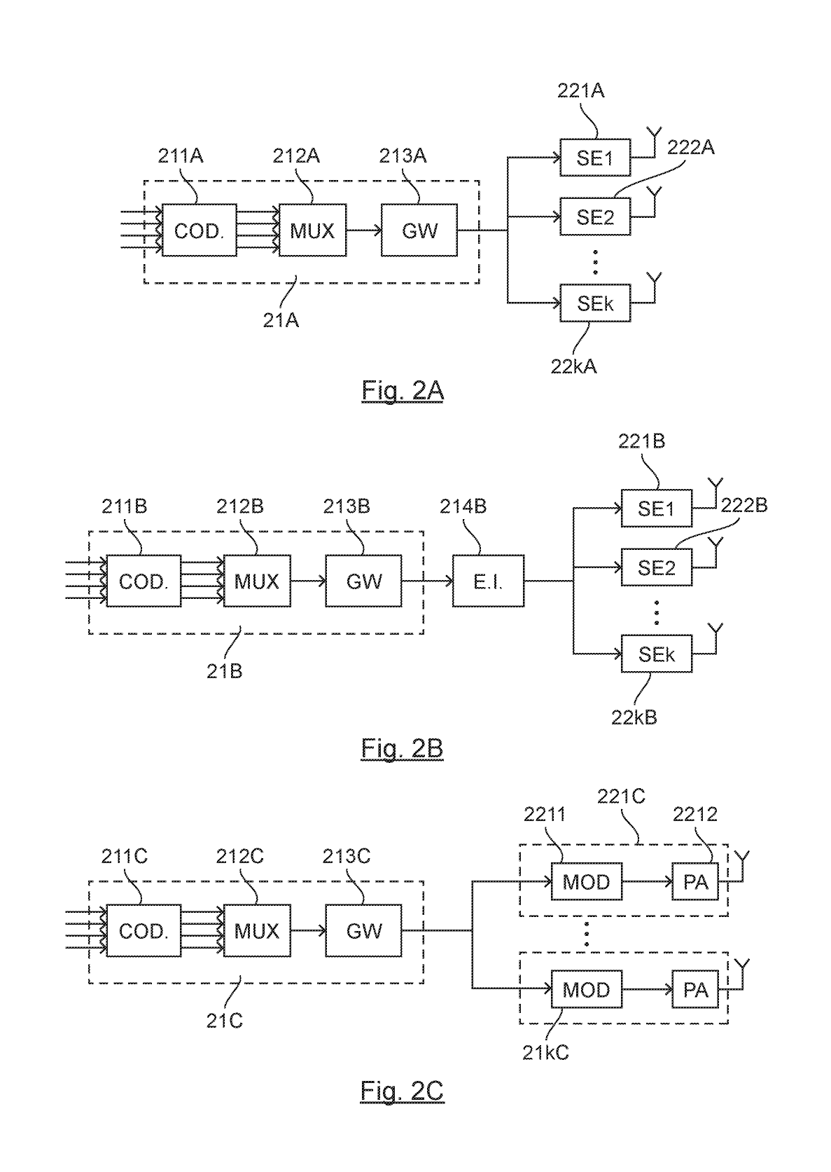

If we take the context of a broadcasting network comprising, as illustrated in FIGS. 2A to 2C, a network head-end and at least one distant transmission site, the modulated signal obtained from the candidate signal selected during the selection step 13 is intended for broadcasting by at least one of the transmission sites. It can be noted that the method of selection according to the invention can be implemented at different levels of the broadcasting network.

### Implementation at the Network Head-End

According to a first example, illustrated in FIG. 2A, such a method of selection can be implemented at the network head-end 21A, for example in a gateway 213A (GW) of the network head-end or another independent device. In this case, the candidate signals are transport streams built from the content or contents to be broadcast (payload data).

More specifically, the content or contents to be broadcast are encoded by at least one encoder 211A, then, as the case may be, multiplexed by a multiplexer 212A. The data stream output from the multiplexer 212A is for example of the MPEG2-TS type according to the DVB-T2 standard (as described in the document ISO 13818-1—December 2000) or IP, ALP according to the ATSC-3 standard. This data streams is shaped by the gateway 213A which generates several candidate signals, for example of the T2-MI type according to the DVB-T2 standard (as described in the document ETSI TS 102 773 V1.4.1—March 2016) or STL according to the ATSC-3 standard (as described in the document “ATSC Candidate Standard: Scheduler/Studio to Transmitter Link”, S32-266r16, September 30, 2016). The gateway 213A implements the method of selection described here above to test the candidate signals obtained from this data stream and select one of the candidate signals, i.e. the selected candidate signal is then transmitted to the different transmission sites 221A, 222A, . . . , 22kA.

Such an implementation is advantageous in that it avoids a duplication of the selection processing at each transmission site and homogenizes the optimizing of the PAPR of the modulated signals broadcast by the transmission sites.

According to this first example, so long as the selected candidate signal (or transport stream) is compliant with the broadcasting standards implemented at the network head-end/gateway (for example of the T2-MI or STL type), the solution is compatible with the transmitters of the transmission sites, i.e. it is transparent for these transmitters.

Besides, as indicated here above, several mechanisms attached to different communications layers consume bandwidth starting from the network head-end. These mechanisms are especially mechanisms for bit-rate adaptation and insertion of tables and headers relating to the different communications layers. They can be grouped together under signaling and padding mechanisms. The shifting, towards the network head-end, of the PAPR-optimizing processing operation by the selection of a specific candidate signal enables this processing to be associated with the signaling and padding mechanisms, in order to avoid additional bandwidth losses.

Such signaling and padding mechanisms can therefore be exploited as degrees of freedom in order to create multiple scenarios, i.e. multiple candidate signals.

### Implementation in an Intermediate Device

According to a second example, illustrated in FIG. 2B, such a method of selection can be implemented in an intermediate device 214B, located between the network head-end 21B and the transmission site or sites 221B, 222B, . . . , 22kB. Such an intermediate device 214B is for example associated with a region/hub (several transmission sites belonging to a same region/hub). In this case, the candidate signals are built out of a transport stream generated by the network head-end and received by the intermediate device.

More specifically, the content or contents to be broadcast are encoded by at least one encoder 211B and then, as the case may be, multiplexed by a multiplexer 212B. The data stream output from the multiplexer 212B is for example of the MPEG2-TS, IP, or ALP type. This data stream is shaped by the gateway 213B which generates a transport stream, for example of the T2-MI or STL type.

The intermediate device 214B implements a processing of the data stream generated by the network head-end, for example a de-encapsulating operation to obtain the payload data and the “additional” data transported in the transport stream. The intermediate device then carries out the method of selection according to the invention to select a candidate signal used to generate a modulated signal that is to be sent out by a transmission site having a PAPR value that complies with a predetermined criterion. Finally, the intermediate device carries out a processing of the selected candidate signal, for example a re-encapsulation, to generate a new transport stream, for example a T2-MI or STL type stream. The new transport stream is then transmitted to the different transmission sites 221B, 222B, . . . , 22kB.

The advantages of this second example are similar to those of the first example.

### Implementation in at Least One Transmission Site

According to a third example illustrated in FIG. 2C, such a method of selection can be implemented in at least one of the transmission sites 221C, 22kC. In this case, the candidate signals are built out of a transport stream generated by the network head-end or by an intermediate device and received by the transmission site or sites.

More specifically, the content or contents to be broadcast are encoded by at least one encoder 211C and then, as the case may be, multiplexed by a multiplexer 212C. The data stream output from the multiplexer 212C is for example of an MPEG2-TS, IP, or ALP type. This data stream is shaped by the gateway 213C which generates a transport stream, for example of the T2-MI or STL type. The transport stream is then transmitted to the different transmission sites 221C, . . . , 22kC.

For example, the transmission site 221C processes the transport stream generated by the network head-end or by the intermediate device, for example a de-encapsulating operation, to obtain the payload data and the “additional” data transported in the transport stream. The transmission site then carries out the method of selection according to the invention to select a candidate signal enabling the generation of a modulated signal to be send by a transmitter of the transmission site having a PAPR value that meets a predetermined criterion. The selected candidate signal is modulated 2211 according to an OFDM modulation for example and its power is amplified 2212. Finally, the transmission site 221C sends the modulated signal generated from the selected candidate signal.

It can be noted that such a data-selection technique according to the invention, optimizing the PAPR value of a modulated signal, can be implemented in addition to another PAPR reducing/optimizing technique. For example, the technique according to the invention can be implemented in the network head-end and a classic PAPR reducing/optimizing technique can be implemented in transmission sites in a same broadcasting network.

Here below, we describe several embodiments according to which the method of selection and therefore the PAPR optimizing processing operation is implemented upstream to the modulation processing of the transmission sites. Placing the scenarios in parallel then relies on the degrees of freedom upstream in the physical layer or even in the higher communications layers.

### Generating Candidate Signals

Here below, we describe several examples of generation of candidate signals, achieved by modifying at least one value and/or a length and/or a position of at least one piece of data of the signaling, padding and/or proprietary type.

### Creation of Candidate Signals Through Signaling

Besides payload data, the different communications layers contain additional data comprising especially signaling data. This signaling enables the encapsulation and de-encapsulation processing of the layer considered. They take for example the form of headers, specific packets and/or tables.

Although these pieces of signaling data are often standardized, degrees of freedom are nevertheless allowed.

Thus, certain standards, when they were being defined, set apart a reserved surplus space for signaling, known as a reserved field or fields. This surplus is used if there is any further development of the standard, in which case the space can be used for new fields. It can also serve to structure the signaling in order to facilitate its encoding and decoding, for example by the adjusting of its length on multiples of eight for processing an eight-bit byte.

Since the value of these reserved fields is not routinely dictated by the standards, it is possible to play on the different values of these fields in order to create multiple candidate signals.

For example, as illustrated in FIG. 3, the layer N carries payload data D and a header H. The header H of the layer N carries signaling data and at least one field reserved for signaling. By assigning different values to this reserved field or fields (for example 111 . . . 111, 000 . . . 000, 010 . . . 010), it is possible to generate different candidate signals. According to this example, the different candidate signals generated are thus identical, except for the value of this reserved field or of these reserved fields.

In particular, it can be noted that according to certain standards, the value of these reserved fields is imposed. Thus, the first candidate signal can be built from this imposed value. Although imposed, this value must be overlooked by the de-encapsulation processing operation implemented by a receiver (for example a classic digital television receiver). Thus, it is possible to build candidate signals having particular values in the reserved fields, and the selection of a data signal, built with particular values, in the reserved fields is transparent for the receiver.

If we take the context of the DVB-T2 standard, at the layer L1, according to a first example, such reserved fields are present in the fields L1pre and L1post of the physical communications layer L1 defined in the document ETSI EN 302 755 V1.4.1 (July 2015). Such reserved fields are denoted as RESERVED or RESERVED_i, with i being an integer.

The value of these reserved fields is not defined by the standard and can therefore be exploited to create multiple candidate signals. Thus, a reserved field of N bits can take 2^{N} values and therefore generate an equivalent number of different candidate signals. It must be noted that the fields reserved for signaling L1 ever since the version 1.2.1 of the standard, can also serve to balance the number of ‘0s’ and ‘1s’ in the signaling (this is known as bias balancing). This bias balancing can be combined with the solution proposed for the selection of a data signal leading to the generation of modulated signal having optimized PAPR.

If we take the context of the ATSC-3 standard, at the layer L1 according to a second example, such reserved fields are present in the parts called L1-Basic and L1-Detail of the physical communications layer L1 defined in the document “ATSC Standard :Physical Layer Protocol (A/322)”, Sep. 7, 2016. There are two reserved fields, one in the L1-Basic part, denoted as L1B_RESERVED, and the other in the L1-Detail part, denoted as L1D_RESERVED.

According to the ATSC-3 standard, all the bits of the reserved fields must have a value ‘1’. For example, the first candidate signal is built in meeting this constraint. However, since the receivers overlook the value of these reserved fields, it is possible to modify the value of these fields while remaining compatible with the receivers. As in the solution relating to DVB-T2, the multiplicity of values generates multiple candidate signals.

If we take the context of the DVB-T or DVB-T2 standards at the layer L2, according to a third example, such reserved fields are present in the signaling of the MPEG2-TS streams. In particular, in the definition of the transport packets, there is an adaptation field denoted as “ADAPTATION_FIELD”. When this adaptation field is used, there are reserved fields in the signaling of the MPEG2-TS stream. These reserved fields are denoted as “RESERVED”.

It is therefore possible to work with the values of these reserved fields to generate multiple candidate signals. As in the case of the ATSC-3 standard, according to these DVB-T or DVB-T2 standards, all the bits of the reserved fields must be at ‘1’. However, since the receivers overlook the value of these reserved fields, it is possible to modify the value of these fields while remaining compatible with the receivers.

Instead of working with the value of the reserved fields to generate candidate signals, or as a complement to this approach, it is possible as illustrated in FIG. 4 to work on the length of these reserved fields.

For example, as illustrated in FIG. 4, the layer N carries payload data D and a header H. The header H of the layer N carries signaling data and at least one field reserved for signaling. By parameterizing different lengths to this reserved field or these reserved fields (for example I=A, I=B), it is possible to generate different candidate signals. According to this example, the different candidate signals generated are thus identical, except for the length of this reserved field or fields.

If we take the context of the ATSC-3 standard, at the layer L1, it is possible to play on the length of the reserved field of the part L1-Detail of the signaling L1. Indeed, in the part L1-Basic, the field denoted as “L1B_L1_Detail_size_bytes” indicates the total length in bytes of the part L1-Detail. In the latter case, the size of the reserved field “L1D_reserved” is adjusted according to the previous parameter. It is thus possible to increase the value of the field “L1B_L1_Detail_size_bytes” to increase the size of the field “L1D_reserved”, and thus obtain different candidate signals.

Instead of or in addition to playing on the value and/or the length of these reserved fields, it is also possible to play on the position of the signaling information to generate several candidate signals.

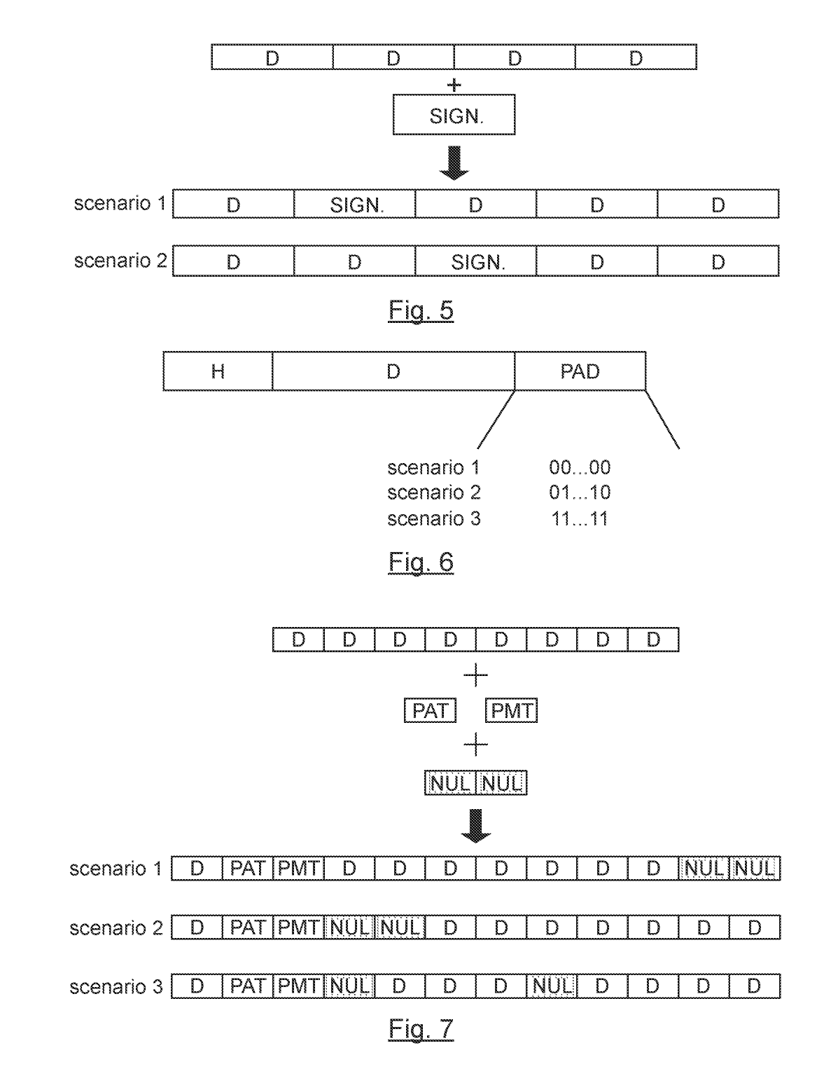

Indeed, the pieces of signaling data are classically inserted between the payload data in the data stream by means of headers or specific packets associated with a communications layer. In addition to the value or the format of this signaling, there is a possible degree of freedom in the way in which signaling is inserted in time into the stream. The position of the headers is generally fixed by the standards but, for specific packets, it is rather time-slots of insertion between the payload data that are defined. It is then possible to play on the time of insertion of these packets (in remaining, if that is desired, within standardized time-slots) to generate numerous candidate signals as illustrated in FIG. 5, where D represents a data packet of the layer N, and SIGN represents a signaling packet of the layer N. According to this example, the different candidate signals generated are identical, except for the position of the signaling packet.

If we take the context of the ATSC-3 standard, at the layer L2, it is possible to play on the insertion of the tables LLS (LMT, RDT, SLT . . . ) to modify the structure of the data signals and thus obtain different candidate signals.

More specifically, in the document “ATSC Standard: Link-Layer Protocol (A/330)”, Sep. 19, 2016, the ATSC-3 standard defines different signaling tables introduced into the data stream. The tables LMT and RDT are introduced by ALP encapsulation while the tables SLT, RRT, CAP and System Time are introduced upstream to this encapsulation. The rate of insertion is limited by the standard to a minimum of once every five seconds. It is therefore possible to play on the range of this insertion rate so long as we remain within the boundaries of the above limit. For example, for the LMT table and for the ATSC-3 frame, it may be decided to transmit the table at the very beginning, after the first ALP packet of payload data, after the second ALP packet of payload data, etc., thus generating an equivalent number of candidate signals.

If we take the context of the DVB-T or DVB-T2 standards, in the layer L2, it is also possible to play on the insertion of the signaling tables (PAT, PMT, . . . ) to modify the structure of the data signals and thus obtain different candidate signals.

More specifically, several signaling tables are defined in the MPEG2-TS standard, for example the tables PAT and PMT. Their rates of insertion or repetition are limited by the standard (ETSI TR 101 290 V1.3.1—July 2014) to the minimum of one table every 0.5 seconds. Again, it is possible to play on this insertion in order to generate different candidate signals.

### Creation of Candidate Signals Through Padding

Instead of playing on the signaling data/information to generate candidate signals, or as a complement, it is possible to play on the padding data/information.

Indeed, in addition to signaling type additional data, there are also padding type additional data besides the payload data of the data stream. The padding is found indeed on different communications layers to provide bandwidth with a view to inserting signaling or for problems of bit-rate adaptation. It can be recalled especially that bit-rate adaptation is necessary to convert a stream of variable bit rate into a stream of constant bit rate. In practice, the bandwidth of a transmission is never used completely and the padding is always found on at least one of the communications layers. This padding can offer degrees of freedom for the generation of the candidate signals in playing on its value, its length and/or its distribution in the data signal.

According to a first example, it is possible to play on different values for the padding in order to create multiple scenarios as presented here above for the reserved fields of the signaling.

In particular, it can be noted that, according to certain standards, the value of the padding, even if it is imposed, must be overlooked by the receiver. Thus, the selection of a data signal built with a particular values for the padding is transparent for the receiver. Again, at least one of the candidate signals can be built in complying with the value dictated for the padding.

If we take the context of the DVB-T or DVB-T2 standards, at the layer L2/L1, it is also possible to play on the value of at least one padding packet to obtain different candidate signals.

More specifically, the MPEG2-TS standard defines a specific padding packet, called a zero packet. Its header is specified in this standard. By contrast, the value of these pieces of data is free. By modifying the data fields of a zero packet, it is therefore possible to generate multiple candidate signals while preserving a solution compatible with the MPEG2-TS standard.

If we take the context of the DVB-T or DVB-T2 standards at the layer L2, the MPEG2-TS standard also defines a padding field in the signaling. More specifically, in the definition of the transport packets, there is an adaptation field called “ADAPTATION_FIELD”. When this adaptation field is used, there is a padding field in the signaling of the MPEG2-TS stream. This padding field is denoted as “STUFFING”. Again, the value of this padding field can be modified to generate numerous candidate signals. As in the case of the reserved fields, the standard dictates that all the bits of this padding field should have a value equal to ‘1’. However, since the receivers overlook the value of this padding field, it is possible to modify the value of this field while remaining compatible with the receivers.

If we take the context of the DVB-T2 standard, in the physical layer L1, padding can be introduced during the creation of a baseband frame, also called a “BB frame”. As illustrated in FIG. 6, this padding is introduced after the payload data in order to completely fill the frame. The baseband frame therefore comprises a header H (“BB HEADER”), a field carrying the payload data D (“DATA FIELD”), and a padding field PAD (“PADDING”). As the case may be, in certain configurations, an inband signaling field (“INBAND SIGNALLING”) is interposed between the payload data and the padding.

The value of the padding field can be modified to generate several candidate signals (for example 00 . . . 00, 01 . . . 01, 11 . . . 11). Again, the standard can impose a zero value on the bits of this padding field. Since the receivers overlook the value of this padding field, it is possible to modify the value of this field while remaining compatible with the receivers. The multiplicity of values therefore enables the generation of multiple candidate signals.

If we take the context of the ATSC-3 standard, at the physical layer L1, padding can be introduced during the creation of a baseband packet, also called a “BB packet”. This padding is introduced between the header and the payload data of the packet in the extension field “EXTENSION_FIELD”. Thus, a baseband packet comprises a header comprising a base field (“BASE FIELD”) and an optional field (“OPTIONAL FIELD”), a padding field (“EXTENSION_FIELD”), and a field carrying payload data (“DATA FIELD”).

The value of the padding field can be modified to generate several candidate signals (for example 00 . . . 00, 01 . . . 01, 11 . . . 11). Again, the standard can impose a zero value on the bits of this padding field. Since the receivers overlook the value of this padding field, it is possible to modify the value of this field while remaining compatible with the receivers.

Instead of playing on the value of the padding to generate candidate signals, or as a complement to this approach, it is possible to play on the distribution of the padding.

Indeed, similarly to the degree of freedom offered by the time of insertion of the signaling, numerous candidate signals can be generated in playing on the distribution of the padding within the data signal. When this padding is done by means of specific packets, the time of insertion of these packets alongside other data of the signal can be modified, thus creating different candidate signals. For example, in the layer N, a padding packet can be inserted between a first and a second data packet to generate a first candidate signal, between a second and a third data packet to generate a second candidate signal, between a third and a fourth data packet to generate a third candidate signal, etc.

If we take the context of the DVB-T or DVB-T2 standards, at the level of the layer L2/L1, it is possible to play on the position of the padding data to generate different candidate signals.

More specifically, as already indicated, the MPEG2-TS standard defines a specific padding packet called a zero packet. The insertion of this packet alongside the payload data packet and signaling packets in a data signal represents a degree of freedom for generating several candidate signals.

For example, as illustrated in FIG. 7, if we consider payload data packets to be broadcast D, PAT table and PMT table type signaling packets and zero packet type padding packets, a first candidate signal can be generated in placing the two zero packets after the payload data packets, a second candidate signal can be generated in placing the two zero packets after the signaling packets, a third candidate signal can be generated by placing a zero packet after the signaling packets and zero packet between the payload data packets, etc.

When the padding is done directly beside the payload data in a “packet” of a communications layer, it is possible to play on the distribution of the padding on several packets to create multiple scenarios. In other words, on a determined packet, it is possible to decide to allocate less padding, and the surplus is then distributed among other packets.

If we take the context of the DVB-T2 standard, at the layer L1, the padding can be introduced during the creation of a baseband frame (BB frame). A baseband frame is then considered to be a “packet” of the physical layer L1.

As we saw earlier with reference to FIG. 6, the padding PAD is introduced after the payload data D in order to completely fill the baseband frame. If we consider these baseband frames for a given time slot, for example the duration of a DVB-T2 frame, the padding can be distributed over the baseband frames in numerous ways. Each distribution leads to a different candidate signal.

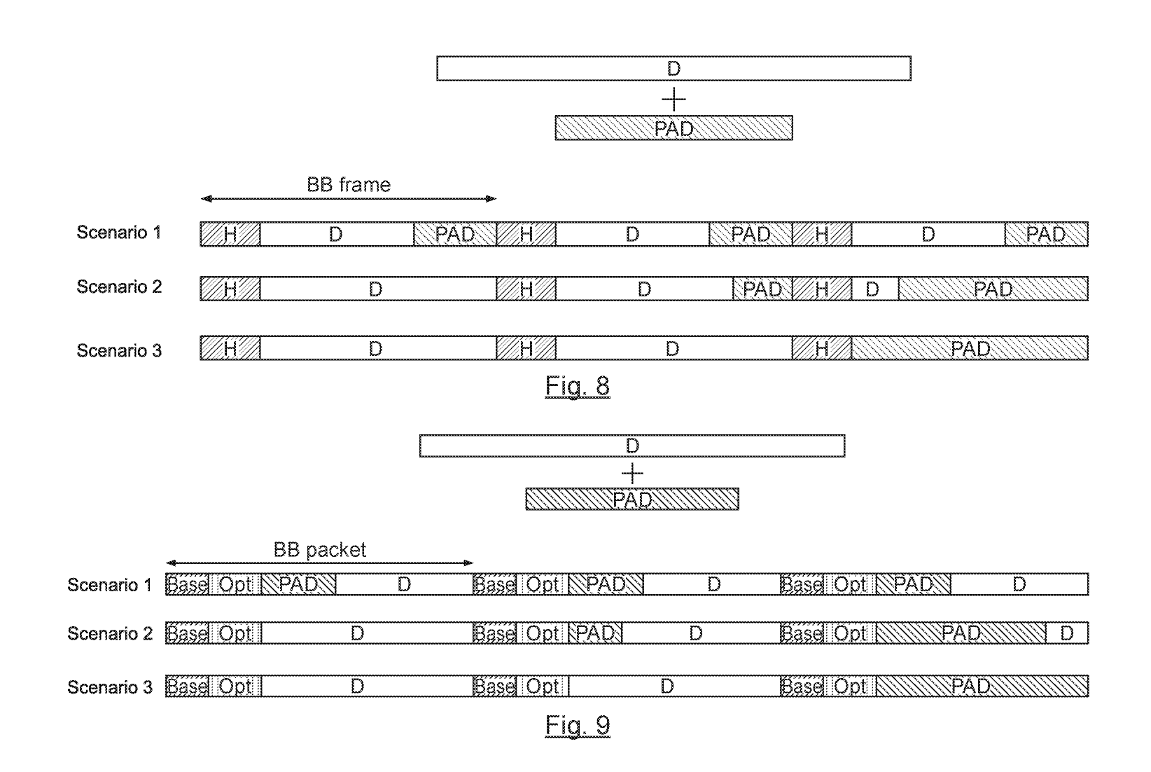

Thus, as illustrated in FIG. 8, a first candidate signal can be generated by building baseband frames each comprising a header H, payload data D, and padding data PAD, a second candidate signal can be generated by building at least one baseband frame comprising a header H and payload data D, and at least one baseband frame comprising a header H, payload data D and padding data PAD, a third candidate signal can be generated by building at least one baseband frame comprising a header H and payload data D and at least one baseband frame comprising a header H and padding data PAD, etc.

If we take the context of the ATSC-3 standard, at the layer L1, padding can be introduced during the creation of a baseband packet.

Similarly to DVB-T2, for a given time slot, the ATSC-3 padding can be distributed in several baseband packets in numerous ways. Each distribution leads to a different candidate signal.

For example, as illustrated in FIG. 9, a first candidate signal can be generated by building baseband packets each comprising a header (BASE and OPT fields), padding data PAD, and payload data D, a second candidate signal can be generated by building at least one baseband packet comprising a header and payload data D and at least one baseband packet comprising a header, padding data PAD and payload data D, a third candidate signal can be generated by building at least one baseband packet comprising a header and payload data D, and at least one baseband packet comprising a header and a padding data PAD, etc.

### Creation of Candidate Signals Through Proprietary Data

Finally, candidate signals can be generated by adding at least one piece of proprietary data and by playing on the value, the length and/or the position of this proprietary data.

### Selection Device

Finally, referring to FIG. 10, we present the simplified structure of a selection device implementing a technique for selecting a data signal according to one embodiment of the invention.

Such a device, for example integrated into a gateway of a network head-end, comprises a memory 101 (comprising for example a buffer memory), and a processing unit 102 (equipped for example with at least one processor, FPGA or DSP), controlled or pre-programmed by an application or a computer program 103 implementing the method for selecting a data signal according to one embodiment of the invention.

At initialization, the code instructions of the computer program 103 are for example loaded into a RAM and then executed by the processing unit 102. The processing unit 102 inputs at least one content to be broadcast, possibly in a transport stream. The transport unit 102 implements the steps of the selection method described here above according to the instructions of the computer program 103, to select a candidate signal, the modulation of which delivers a modulated signal presenting a PAPR complying with a predetermined criterion.

To this end, according to one embodiment, the processing unit 102 activates a first modulator modulating a first data signal carrying at least one content to be broadcast, called a first candidate signal, at least one second modulator modulating a second data signal carrying said at least one content to be broadcast, called a second candidate signal, said second candidate signal having a structure and/or at least one piece of data different from said first candidate signal, and a module for the selection, from amongst the candidate signals, of the candidate signal for which the modulation delivers a modulated signal having a PAPR complying with this predetermined criterion.

1. A method of selecting a data signal implementing the following acts by a device on a network:
a first act of modulating a first data signal carrying at least one content to be broadcast, called a first candidate signal, said first candidate signal carrying payload data and additional data associated with a communications layer,
at least one second act of modulating a second data signal carrying said at least one content to be broadcast, called a second candidate signal, said second candidate signal carrying said payload data and additional data associated with said communications layer, said additional data being distributed differently in the second candidate signal, relative to the additional data in said first candidate signal, and
an act of selecting from amongst said first and second candidate signals, the candidate signal for which the modulating delivers a modulated signal having a peak-to-average power ratio (PAPR) meeting a predetermined criterion.

2. The method of selection according to claim 1, wherein said predetermined criterion belongs to the group consisting of:
a minimum peak-to-average power ratio,
a peak-to-average power ratio below a predetermined threshold.

3. The method of selection according to claim 1, wherein said additional data of the first candidate signal or of the second candidate signal are additional data of a signaling, padding and/or proprietary type.

4. The method of selection according to claim 1, wherein said second candidate signal comprises at least one piece of additional data of a signaling, padding and/or proprietary type having a value different from that of a corresponding piece of additional data of said first candidate signal.

5. The method of selection according to claim 1, wherein said second candidate signal comprises at least one piece of additional data of a signaling, padding and/or proprietary type having a length different from that of a piece of corresponding additional data of said first candidate signal.

6. The method of selection according to claim 1, wherein the method is implemented in a broadcasting network comprising a network head-end and at least one distant transmission site, and said modulated signal obtained by modulating the candidate signal selected by said selecting act is selected for broadcasting by at least one of said transmission sites.

7. The method of selection according to claim 6, the method and device are implemented in said network head-end, and said candidate signals are transport streams built out of said at least one content to be broadcast.

8. The method of selection according to claim 6, wherein the method and device are implemented in an intermediate device located between said network head-end and said at least one transmission site, and said candidate signals are built out of a transport stream generated by said network head-end and received by said intermediate device

9. The method of selection according to claim 6, wherein the method and device are implemented in at least one of said transmission sites and said candidate signals are built out of a transport stream generated by said network head-end and received by said at least one transmission site.

10. The method of selection according to claim 1, wherein said first and second candidate signals are generated by inserting the added data amongst the payload data at different insertion times.

11. A device for selecting a data signal comprising:
a processor; and
a non-transitory computer-readable medium comprising instructions stored thereon, which when executed by the processor configure the device to perform acts comprising:
modulating a first data signal carrying at least one content to be broadcast, called a first candidate signal, said first candidate signal carrying payload data and additional data associated with a communications layer,
modulating a second data signal carrying said at least one content to be broadcast, called a second candidate signal, said second candidate signal carrying said payload data and additional data associated with said communications layer, said additional data being distributed differently in the second candidate signal, relative to the additional data in said first candidate signal,
selecting, from amongst said first and second candidate signals, the candidate signal for which the modulating delivers a modulated signal having a peak-to-average power ratio meeting a predetermined criterion.

12. A non-transitory computer-readable medium comprising instructions stored thereon and implementing a method of selecting a data signal when the instructions are executed by a processor of a device on a network, wherein the method comprises:
a first act of modulating a first data signal carrying at least one content to be broadcast, called a first candidate signal, said first candidate signal carrying payload data and additional data associated with a communications layer,
at least one second act of modulating second data signal carrying said at least one content to be broadcast, called a second candidate signal, said second candidate signal carrying said payload data and additional data associated with said communications layer, said additional data being distributed differently in the second candidate signal, relative to the additional data in said first candidate signal, and
an act of selecting from amongst said first and second candidate signals, the candidate signal for which the modulating delivers a modulated signal having a peak-to-average power ratio (PAPR) meeting a predetermined criterion.
